(19) United States
(12) Patent Application Publication
(10) Pub. No.: US 2008/0284189 A1
(43) Pub. Date: Nov. 20, 2008

(54) Loading Space Arrangement

(76) Inventors: Alain Leroy, Diessen-Dettenschwang (DE); Heinz Pschorn, Dachau (DE); Robert Braun, Berg (DE); Dirk Legler, Weil (DE); Michael Koelbl, Neuried (DE); Oliver Vogt, Munchen (DE); Thomas Rudolph, Hechendorf (DE); Thomas Jakimenczuk, Hohenkirchen (DE)

Correspondence Address: DICKINSON WRIGHT PLLC, 1901 L. STREET NW, SUITE 800, WASHINGTON, DC, 20036, US

(21) Appl. No.: 11/908,369

(22) PCT Filed: Mar. 10, 2006
(86) PCT No.: PCT/DE06/00439

§ 371 Date: Jun. 13, 2008

(30) Foreign Application Priority Data
Mar. 11, 2005 (DE) 10 2005 011 681.7

(51) Int. Cl. B62D 33/08

(52) U.S. Cl. 296/26.11

(57) ABSTRACT

The invention relates to a loading space arrangement for a motor vehicle comprising a loading space (1) having a loading area, a loading space gate (3), which can pivot about an essentially horizontal axis and which has a holding surface, the loading area and the holding surface, when in a loading position, being located in a plane or in planes oriented approximately parallel to one another. The loading space arrangement has an essentially box-shaped transport device (5) that, in the loading position, can be detachably mounted on the holding surface of the loading space gate (3).

The present invention relates to a cargo space arrangement for a motor vehicle according to the definition of the species of Claim 1.

Cargo space arrangements of the type defined in the preamble are already known from the state of the art. One disadvantage of the known cargo space arrangement is that they provide only limited stowage space for a vehicle without allowing a very great variability.

This is where the present invention begins.

The object of the present invention is to propose a cargo space arrangement in which the stowage space available to the motor vehicle can be enlarged easily and in a variable manner.

This object is achieved by a cargo space arrangement of the type defined in the preamble having the features of the characterizing part of Claim 1. The subclaims pertain to advantageous further embodiments of the invention. It is proposed according to the present invention that the cargo space arrangement shall have an essentially box-shaped transport device which is detachably mounted on the receiving surface of the cargo space gate in the loading position. Thanks to this feature according to the present invention, the stowage space available for the motor vehicle can be enlarged easily as needed.

In an advantageous embodiment, the transport device has at least a cover element that is suitable for exposing and then closing again an interior space of the transport device. With the help of the at least one cover element, the interior space of the transport device can easily be exposed and reclosed again. By opening the cover element, the user can thus easily reach into the interior space of the transport device to place the cargo that is to be transported in the transport device and/or remove it therefrom again. The at least one cover element may also effectively prevent moisture from penetrating into the interior of the transport device.

According to a preferred further embodiment, the transport device has a rear wall which is pivotable about a horizontal axis or about a vertical axis. The pivotable rear wall offers the users an additional or alternative possibility from reaching into the interior of the transport device and/or the cargo space of the vehicle.

In an advantageous embodiment, the rear wall may have at least one pivotable cargo space gate. The gate element, which is preferably pivotable about an essentially horizontal axis, makes it possible for elongated goods that extend beyond the rear wall of the transport device, for example, to be transportable with the help of this cargo space arrangement. The user can pivot the at least one gate element and can pass the elongated goods that are to be transported through the resulting opening and stow them in the cargo space arrangement.

In a particularly preferred embodiment, the cargo space arrangement has a transport platform which can be transferred from the interior of the transport device into the cargo space. This transport platform facilitates loading and unloading of the cargo space arrangement presented here. The user is able to very easily deposit the cargo that is to be transported on the movable transport platform and optionally transfer it then to the cargo space of the vehicle. The space remaining in the interior of the transport device may then be used for unloading, and the transport platform may be transferred back out of the cargo space of the vehicle into the interior of the transport device, so that the cargo deposited on the transport platform can be removed from the transport platform again later.

The cargo space arrangement preferably has guidance means in which the transport platform is accommodated. For example, a combination of rails and rollers as well as other comparable guidance means may be used, said means being equipped so that they readily allow a transfer of a transport platform from the interior of the transport device into the cargo space of the vehicle and vice-versa.

In a preferred embodiment the transport platform has at least two bordering walls suitable for bordering the transport platform at the sides. These two bordering walls which are arranged opposite one another serve, among other things, to increase stability and may also prevent the cargo from falling off the transport platform at the sides.

In a particularly advantageous embodiment, it is proposed that the transport platform shall have at least one first end wall that seals off the cargo space of the motor vehicle when the transport platform is transferred into the cargo space. The first end wall may act as a bulkhead wall and thereby seal off the cargo space and thus also the interior of the vehicle, so that the vehicle can be operated even with the transport device, which is mounted on the receiving surface of the cargo space gate, without allowing harmful exhaust gases to penetrate into the cargo space and/or the interior of the vehicle in the meantime.

In an advantageous embodiment, it is possible for the transport platform to have at least one end wall opposite the first end wall. Together with the first end wall and the two side bordering walls, a transport space that is limited on all sides is made available on the transport platform, so that even bulk cargo or optionally even liquids, for example, could be transported in the cargo space.

In an especially preferred embodiment, to prevent the transport platform from being able to move back and forth unintentionally while the vehicle is being driven, for example, the cargo space arrangement may have locking means suitable for locking the transport platform in a desired position to prevent slippage.

In addition to the extremely high variability made possible with the inventive cargo space arrangement, another advantage of the present invention is that the stowage space of the motor vehicle can easily be increased substantially. Falling of cargo while loading and unloading can be effectively prevented.

Additional features and advantages of the present invention will now be illustrated on the basis of the following description of a preferred exemplary embodiment with reference to the accompanying figures, in which:

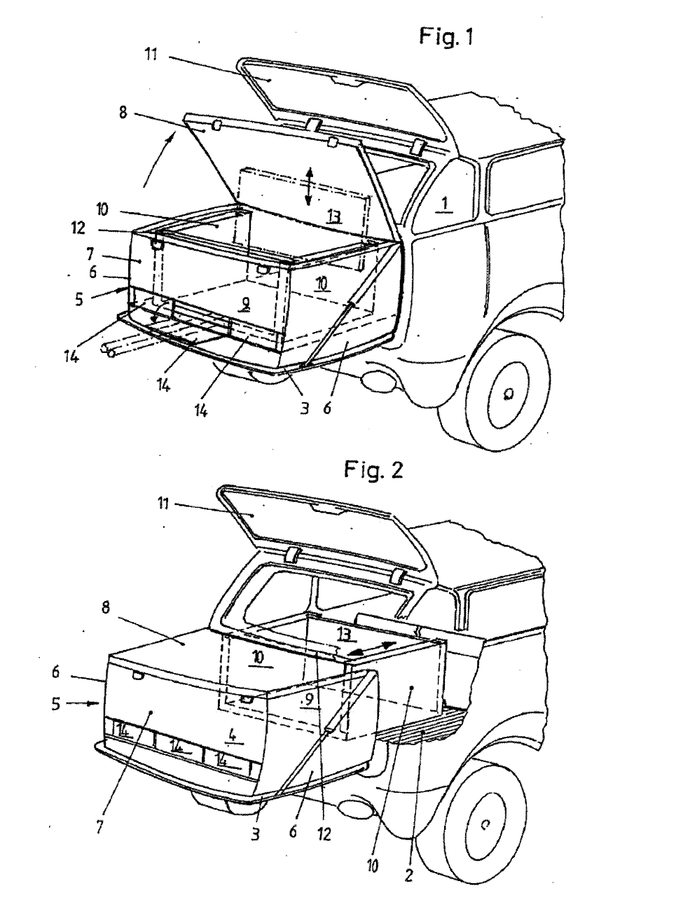

FIG. 1 shows a perspective view of an inventive loading arrangement for a motor vehicle in a first operating position;

FIG. 2 shows a perspective view of the cargo space arrangement for a motor vehicle according to FIG. 1 in a second operating position.

The inventive loading arrangement for a motor vehicle is shown in perspective view in two operating positions in FIG. 1 and FIG. 2.

The cargo space arrangement comprises a cargo space 1 with a loading surface 2 in the interior of a motor vehicle, a cargo space gate 3 that is pivotable about an essentially horizontal axis of rotation and has a receiving surface 4 as well as an essentially box-shaped transport device 5 which is open on a side facing the cargo space 1 of the motor vehicle in this exemplary embodiment.

In a loading position obtained by pivoting the cargo space gate 3 into an essentially horizontal position, the loading surface 2 of the cargo space 1 and the receiving surface 4 of the cargo space gate 3 are situated essentially in one plane. In the loading position just described, the transport device 5, which is designed essentially in the form of a box and comprises means for a detachable mounting on the loading surface 4, can be detachably attached to the receiving surface 4 of the cargo space gate 3.

In this exemplary embodiment, the transport device 5 has two side walls 6, a rear wall 7 and a cover element 8, which border an interior space of the transport device 5 toward the outside. The cover element 8 in this exemplary embodiment is pivotably connected to the transport device 5 by means of a hinge mechanism and may be opened by the user and closed again as needed, thereby allowing access to the interior space of the transport device 5.

The rear wall 7 of the transport device 5 may preferably also be designed to be pivotable about a horizontal or a vertical axis, so that the interior space of the transport device 5 can be reached.

In this exemplary embodiment, the rear wall 7 also has pivotable gate elements 14 so that as indicated in FIG. 1, elongated goods may also be transported here as needed with the help of the cargo space arrangement disclosed here without having to pivot the rear wall 7.

It can also be seen that in this exemplary embodiment the motor vehicle has a rear window 11 which can be opened and closed by the user. In the open position of the rear window 11, which is illustrated in FIG. 1 and FIG. 2, the user has access to the cargo space 1 of the vehicle to pass cargo through the resulting rear window opening, for example, into the cargo space 1 or to remove it therefrom.

The cargo space arrangement also comprises a movable transport platform 9 which can be transferred from the interior space of the transport device 5 to the loading surface 2 of the cargo space 1 of the motor vehicle. Thus, when the cover element 8 is opened or when the rear wall 7 is opened, the user can deposit the cargo that is to be transported on the movable transport platform 9 and may then transfer it into the cargo space 1 of the motor vehicle. This second operating position in which the transport platform 9 is situated in the cargo space 1 of the motor vehicle is illustrated in a perspective view in FIG. 2. The cargo space arrangement preferably has guidance means in which the transport platform 9 is accommodated. For example, combinations of rails and rollers as well as other comparable guidance means may also be used, these guidance means being equipped so that transfer of the transport platform 9 from the interior space of the transport device 5 into the cargo space 1 of the vehicle and vice-versa are possible.

Bordering walls 10 which border the transport platform 9 at the sides to increase stability and prevent the cargo from falling down from the transport platform 9 at the side are mounted on the transport platform 9. To prevent the transport platform 9 from being able to move unintentionally while driving, locking means are provided (not shown explicitly here). These locking means are furnished so that they can hold the transport platform 9 in the desired position without displacement, e.g., in the interior space of the transport device 5 or in the cargo space 1.

In addition to the two bordering walls 10, at least one first side wall 12 is preferably also provided on the transport platform 9. The first end wall 12 is furnished so that it can seal off the cargo space 1 of the vehicle and thus also the remaining interior of the vehicle and can thus prevent exhaust gas from penetrating into the interior when the transport platform 9 is in the cargo space 1 of the vehicle in the second operating position shown in FIG. 2. The motor vehicle may then also be driven with the transport device 5 placed on the receiving surface 4 of the cargo space gate 3.

A second end wall 13, which is opposite the first end wall 12, is preferably mounted on the transport platform 9. The transport platform 9 together with the two bordering walls 10 and the first end wall 12 and the second end wall 13 then forms a receiving space that is bordered on all sides, so that even bulk goods or liquids can be transported, for example. The transport platform 9 may optionally also have a cover element. The second end wall 13 may also be equipped in such a way that it can seal off the cargo space 1 of the vehicle and thus also the remaining interior of the vehicle and can thus prevent exhaust gases from penetrating into the vehicle when the transport platform 9 is in the interior of the transport device 5 in the first operating position illustrated in FIG. 1. To increase flexibility, the end walls 12, 13 and/or the bordering walls 10 may be detachably mounted on the transport platform 9.

With the help of the cargo space arrangement shown here, the stowage space available for the vehicle can easily be substantially increased. The cargo space arrangement is designed so that in particular it is possible to drive the vehicle with the cargo space gate 4 [sic; 3] opened and with the transport device 5 attached to it without allowing harmful exhaust gases to penetrate into the cargo space 1 and the interior of the vehicle.

Another advantage of the present cargo space arrangement is that it can be used in a highly variable and thus flexible and versatile manner.

### LIST OF REFERENCE NUMERALS

1 Cargo space
2 Loading surface
3 Cargo space gate
4 Receiving surface
5 Transport device
6 Side wall
7 Rear wall
8 Cover element
9 Transport platform
10 Bordering wall
11 Rear window
12 First end wall
13 Second end wall
14 Gate element

1. A cargo space arrangement for a motor vehicle, comprising:
a cargo space having a loading surface;
a cargo space gate that is pivotable about an essentially horizontal axis and comprises a receiving surface,
whereby the loading surface and the receiving surface are arranged in a loading position in one plane or in planes oriented approximately in parallel to one another, characterized in that the cargo space arrangement has an essentially box-shaped transport device which is mounted detachably on the receiving surface of the cargo space gate when in the loading position.

2. The cargo space arrangement of claim 1, characterized in that the transport device has at least one cover element suitable for exposing an interior space of the transport device and closing it again.

3. The cargo space arrangement of claim 1, characterized in that the transport device has a rear wall that can pivoted about a horizontal axis or about a vertical axis.

4. The cargo space arrangement of claim 1, characterized in that the rear wall has at least one pivotable gate element.

5. The cargo space arrangement of claim 1, characterized in that the cargo space arrangement has a transport platform, which can be transferred from the interior space of the transport device into the cargo space.

6. The cargo space arrangement of claim 5, characterized in that the cargo space arrangement has guidance means in which the transport platform is accommodated.

7. The cargo space arrangement of claim 4, characterized in that the transport platform has at least two bordering walls suitable for bordering the transport platform at the sides.

8. The cargo space arrangement of claim 5, characterized in that the transport platform has at least one first end wall suitable for sealing off the cargo space of the motor vehicle when the transport platform is transferred into the cargo space.

9. The cargo space arrangement of claim 8, characterized in that the transport platform has at least one second end wall which is opposite the first end wall.

10. The cargo space arrangement of claim 5, characterized in that the transport device has locking means suitable for locking the transport platform in a desired position so it cannot be displaced.
